(19) United States
(12) Patent Application Publication
(10) Pub. No.: US 2003/0206688 A1
(43) Pub. Date: Nov. 6, 2003

(54) Miniature optical multiplexer/de-multiplexer DWDM device

(76) Inventors: Dennis R. Hollars, San Jose, CA (US); Paul T. Alexander, Morgan Hill, CA (US); Rodrick G. Cross, Pleasanton, CA (US); Randy Dorn, San Jose, CA (US); Kenneth Nelson, Sunnyvale, CA (US); Robert B. Zubeck, Los Altos, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/137,887

(22) Filed: May 3, 2002

(51) Int. Cl. G02B 6/28; G02B 6/26

(52) U.S. Cl. 385/24; 385/47

(57) ABSTRACT

An optical wavelength division multiplexer and de-multiplexer, for single or multi-mode fiber optic communications, includes a base plate that serves as a miniature optical bench, and a series of free-space optical components including collimators, narrow band filters, and highly efficient reflective mirrors mounted to the base plate. The free-space light beam is reflected off of each narrow band filter in a serial manner, whereby narrow bands of light matching the filter are focused into output optical fibers. Each component may be individually adjusted by computer-controlled robotics to achieve accurate optical alignment and provide compensation among the components. The angle of incidence of the light signals at the filters is kept below 10 degrees for DWDM applications, and below about 14 degrees for CWDM applications to minimize polarization dispersion loss. A simplified sealing system provides robust protection from environmental hazards, while further reducing costs and improving manufacturing yields.

### FIELD OF THE INVENTION

This invention relates to the field of fiber optic communication. More particularly, the invention relates to the field of optical wavelength division multiplexers and de-multiplexers that are used in fiber optic communication networking systems.

### BACKGROUND OF THE INVENTION

Information is transmitted in a fiber optic communication system in the form of modulated light waves. For example, an electro-optical switch can be used to modulate a source laser beam to transform a binary electrical signal into an optical signal, which is then coupled into a fiber optical cable. The binary electrical signals can be encoded to improve the bit error rate of the information contained in the binary signal; pulse code modulation (PCM) being just one example. Since optical fibers have many advantageous signal transfer characteristics, including relatively low attenuation and high speed, they are being increasingly utilized to communicate information over large distances.

Two techniques are used to increase the amount of information that can be transferred over an optical fiber. The first technique is called time division (or time domain) multiplexing (TDM). In this technique the laser is modulated at higher and higher rates, and different signals or channels are coupled into the optical fiber in a serial fashion. This technique is limited by the rate at which the laser output can be modulated, and although the rates are being improved, there are physical limits to how high the rates can go.

A second technique is called wavelength division multiplexing (WDM). This technique takes advantage of the fact that light signals at different wavelengths or frequencies may exist simultaneously in an optical fiber with little or no interference of one signal with the others. Therefore a number of optical signals or channels, each at a different wavelength, can be simultaneously combined into one signal that is coupled into the optical fiber. Each channel requires its own laser source operating at a light frequency that is different from each of the others. Of course each individual channel may be used in a TDM mode as previously described. The device that accomplishes the combination of the different channels into one signal that can be coupled into an optical fiber is called an optical multiplexer or a “mux” device. At the other end of the optical cable, the various channels must be separated from each other before the information that they carry can be used. Often the signals are separated by an identical, or almost identical, device to the one used to combine the signals in the first place. The signals are simply sent though the same type of device “backwards”. Used in this way the device is called an optical de-multiplexer or “de-mux” device.

It is desirable to maximize the number of channels, each at a different wavelength, which can be simultaneously transmitted on an optical fiber in order to maximize its available bandwidth. As a consequence, increasing the number of channels crowds them closer and closer together in wavelength space. This crowding is exasperated because laser sources are not available over the entire wavelength range that the fiber optic is capable of being used, and because efficient signal amplifiers are available only in a few restricted wavelength ranges. Hence, at present optical fiber communications occupy a small percentage of the total wavelength range over which the fiber has high transmission capability. In order to use the available wavelength space more efficiently, WDM has evolved into a more crowded channel spacing architecture called DWDM, standing for dense wavelength division multiplexing. In accordance with this technique optical signals of adjacent channels differ in wavelength only slightly. As this difference becomes smaller, combining the signals at one end of the optical fiber and separating them for data recovery at the other end becomes increasing difficult, placing requirements for improved performance on mux/de-mux devices. In addition, current devices are physically rather large and bulky, and they take up a relatively large amount of the available area on a circuit board or other mounting platform. In order to reduce the cost of this technology, ways must be found to reduce its size while improving its performance.

The DWDM technique has historically been very important for the “long haul” telecommunications market, meaning traffic between cities, states, and countries (using submarine cables). The long haul networks are beginning to mature and their growth is slowing. However the local market called “metro”, or “short haul” is just now developing. Short haul networks do not have as much dependence on signal amplification as long haul networks; therefore, more of the available wavelength range can be utilized. In order to cut costs, network designers are using cheaper lasers that have poorer frequency control and thermal response. For this technique to work, the channels must be spaced further apart to avoid signal overlap during thermally induced frequency excursions. This technique is called coarse wavelength division multiplexing or CWDM. Requirements for high performance mux/de-mux devices in the CWDM arena are little eased by the wider channel spacing, because most of the channel width has to have low loss properties to accommodate the larger laser drift. This means that the wavelength separation filters or elements for the CWDM mux/de-mux devices remain about as complex to make as they are for DWDM devices.

An early technique for multiplexing and de-multiplexing a set of optical signals was disclosed by Nosu et al in U.S. Pat. No. 4,244,045, which is hereby incorporated by reference. In his FIG. 12 Nosu shows a glass substrate 60 with parallel surfaces and a series of filters mounted flush on each of the faces. A zigzag optical path at a 15-degree angle to the substrate and filter plane is created with small glass prisms 80, one attached to the substrate at the input and the rest attached to different channel filters using an index matching adhesive. At the time of its disclosure the Nosu device was difficult to assemble, and the individual parts were expensive or impossible to manufacture. For example prisms 80 were required to be identical to maintain the 15-degree optical path, and the filters, being far less sophisticated than those available today, suffered from both thermal and humidity induced wavelength drift. Nosu does note that earlier devices did not recognize the fact that difficulties in channel separation would arise for high angles of incidence at the filters because of polarization effects (S-parallel or P-perpendicular).

Scobey in U.S. Pat. No. 5,786,915 discloses an eight channel multiplexing device in which a continuously variable interference filter is deposited onto each of the opposite parallel sides of an optical block, and is hereby incorporated by reference. The device inherently suffers from low yield, since the continuously variable filters must be very accurately constructed and precisely positioned on each side of the block for the device to be useable. The double filter yield problem is avoided in an embodiment utilizing a continuously variable filter on only one side of the optical block with a uniform mirror on the other. As more demanding filter requirements have evolved, the continuously variable filter has become much more difficult to make, even on just one side.

In a second U.S. Pat. No. 5,859,717, Scobey et al abandon the concept of a continuously variable filter in favor of individual filters mounted on the optical block, which is hereby incorporated by reference. In order to eliminate the need for adhesive in the light path, the optical block has a cut out slot or gap whose height is somewhat less than the diameter of the individual filters. In FIG. 2 of the patent the optical block is element 2, the slot is element 10, and the individual filter is element 32. It is implied that the block and filters can be passively assembled with the necessary alignment accuracy, but in reality this is likely not the case, especially for DWDM applications where the channel spacing is 0.8 nm instead of the 8.0 nm example in Table A of '717. Scobey et al also address the polarization issues mentioned by Nosu and show in FIG. 1 a 3-cavity filter with S and P polarization dispersion that is adequate for telecom use at an angle of incidence (AOI) of 8 degrees. The construction details of the filter are not specified; however, filters with higher numbers of cavities can be more difficult to construct to meet polarization requirements than the illustration with only three cavities.

In U.S. Pat. No. 5,835,517 Jayaraman and Peters disclose a de-multiplexing device in which microlenses are formed on one surface of an optical substrate while a multiple set of Fabry-Perot (i.e. single cavity) filters are formed on the opposite side, which is hereby incorporated by reference. By complex vacuum deposition etching or masking operations, each filter must be individually tuned to the desired laser frequency. This expensive process produces very narrow filter band passes, which allow little tolerance for laser frequency drift. In the form described in the patent, the device is restricted to use as a de-multiplexer, and could not be used in a multiplexing mode.

U.S. Pat. No. 5,894,535 issued to Lemoff and Aronson uses the zigzag optical path concept of previous designs, but it incorporates etched waveguides instead of free space or optical block transmission of the light, which is hereby incorporated by reference. Tapered input waveguide 48 in FIG. 3 prevents the device from being reduced significantly in size. The stated vertex angle of the waveguides is between 3 and 45 degrees, but as previously mentioned, the high angles will not work because of polarization dispersion loss. One of the biggest problems with the Lemoff design is the fact that waveguides contain light propagating at a variety of angles, while the filters 45a, 45b, etc. are angle sensitive. As a consequence the filter response is rolled off or smeared toward the shorter wavelength side, preventing close spacing of the channels as is required in DWDM systems.

Grann in U.S. Pat. No. 6,201,908 B1 reveals a compact de-multiplexing device with a zigzag light path created by filters attached to one side of an optical block and a mirror provided on the other side, which is hereby incorporated by reference. It features passive alignment of the light paths through the filters with pre-molded plastic aspheric lens elements arranged in a linear array. One object of the device is to be cost effective. Details about the range of angles of the optical path are not discussed, but FIG. 7 depicts a cross-section of the optical block and with the zigzag light path through the filters. If the drawing is of uniform scale, the AOI labeled θ lies between 13 and 14 degrees. This would be far too large for a DWDM device with channel spacing of 100 GHz. The polarization dispersion loss would be unacceptable. For wider channel spacings, like CWDM, the device will work as a de-multiplexer with acceptable levels of polarization dispersion loss. However, for use as a multiplexer, the molded aspheric lens array is believed to be far too inaccurate and not nearly stable enough to focus a series of source lasers back onto a single output fiber.

The majority of mux/de-mux units sold in the telecommunications market today do not use the technologies discussed above. While there are a growing number of arrayed waveguide (AWG) devices competing for market share, most mux/de-mux devices utilize individual 3-port tubular modules that can be interconnected to provide the mux or de-mux function. The tubular modules consist of accurately aligned fiber collimators and thin film filters. Fiber collimators provide the means by which light can be directed onto or out of a fiber optic. FIGS. 1A, 1B, and 1C show three types of fiber collimators that are commonly in use.

One of the earliest types of fiber collimator is illustrated in FIG. 1A. For later convenience the entire collimator is referred to as element 1, and it is made up of several individual parts beginning with the optical fiber 2. If it is a single mode fiber, optical fiber 2 consists of a central strand of glass with a diameter of about 9 microns, surrounded by a glass cladding of slightly lower optical index with a diameter of about 125 microns. The cladding is protected from nicks and scratches by a very thin polymer coating. Multi-mode fibers have larger cores and thicker cladding, but are manufactured by the same process. A color-coded jacket 3 is placed over some regions the fiber for further protection and identification. Bare fiber 2 is terminated in glass ferrule 4 where it is secured by an adhesive, and both ferrule and fiber are polished either flat or, more commonly, at an angle to reduce back reflections. In addition anti-reflection coating can be added to any of the components to further reduce reflections. A graded index lens 5 (GRIN lens) is held in position with respect to ferrule 4 by mounting and aligning each element in a glass tube 6. Elements 4 and 5 are held in glass tube 6 by adhesive 7. Great care is taken to prevent any of the adhesive from getting into the optical path. Additional metal cladding is often added over glass tube 6 to further protect the assembly. The useful working distance of the collimator depends upon the degree of parallelism of the emerging beam (indicated by arrows), which in turn depends on how precisely the components are mounted as well as on the optical quality on the GRIN lens.

A second type of collimator is shown in FIG. 1B. It is identical to the one described in FIG. 1A except for the type of lens used to collimate the light. In this collimator GRIN lens 5 in FIG. 1A is replaced by micro-aspheric lens 8. Since the curved outer surface of the lens can be given a non-spherical shape, improved optical performance can be obtained. With this type of collimator working distances in excess of 200 mm have been achieved.

A third type of collimator is shown in FIG. 1C. This collimator uses a ball lens 9 instead of a GRIN lens or an aspheric lens to create a parallel beam of light. The fiber is terminated in a glass ferrule as before, but the components generally are not mounted into tubes. Rather, they are held in V-grooves etched in single crystal silicon substrates. Because of the mature etching processes available for silicon, this type of collimator is most often used in arrays rather than as single units. The ball lenses are low in cost and many sizes are readily available; however, since they are perfectly spherical, the useful working distances are restricted by the optical defect called spherical aberration.

As previously mentioned the majority of mux/de-mux units sold in the telecommunications market today utilize an array of 3-port tubular modules. A typical prior art module 10 is illustrated schematically in FIG. 2A. It consists of two collimators 1 and 1a mounted facing each other with a thin film narrow band interference filter 11 mounted between them. The filter is physically more cubical in shape than indicated in the figure and its back surface is polished at a small angle to reduce reflections. This angle is exaggerated in the figure for clarity. Fiber collimator 1a differs from 1 and those previously discussed in that it has two fibers mounted in the glass ferrule instead of one. The elements are aligned and secured in, for instance, a V-block and then sealed into metal tube 12. The tube is typically 30 to 40 mm long and 5 to 6 mm in diameter. Rubber strain relief boots 13 at each end of the tube restrict sharp bends at the fiber to tube interface, which could cause the fiber to snap. In operation a number of light signals of wavelengths 4 are feed into one port of the module as indicated. Collimator 1a creates a parallel beam of light that is directed to filter 11. One of the light signals λ₁ is transmitted through the filter, and all the rest are reflected. Collimator 1 focuses the transmitted signal back onto an optical fiber where it emerges from the module as shown. If filter 11 is positioned properly, the reflected signals λₙ₋₁ will pass back through collimator 1a, be focused onto the second optical fiber in the ferrule, and exit the module. This 3-port module has become a standard of the communications industry; however, the performance of each device depends very crucially upon accurate optical alignment, and that alignment not changing with temperature or other environmental conditions. Excessive insertion losses are not uncommon with typical production yields running less than 50%.

A typical prior art mux/de-mux device is built up by cascading a number of 3-port modules. This architecture is depicted in FIG. 2B using an eight channel device for illustration. Each 3-port module is identical except for the pass band of the filter. Filter 11a passes only channel 1, filter 11b passes only channel 2, and so on for all eight channels. The λₙ₋₁ output from the first module becomes the input to the second module. The λₙ₋₂ output from the second module is the input to the third module, and so forth for the remaining modules. The modules are mounted into a box and fiber-to-fiber splices are made to connect the modules together in the indicated cascade fashion. The fiber splices are rarely perfect, leading to another source of insertion loss and device degradation. The box has openings in its side for the eight output fibers, the input fiber, and (optionally) a pass through fiber. All these ports are typically arrayed along one side of the box, and it is sealed around its edges and around the fibers to make it more impervious to environmental changes. Strain relief boots help to protect the fibers from breakage due to accidental sharp bends. The size of the box used to house the mux/de-mux device is significantly larger than the size of the individual modules. The size is determined primarily by the allowable bend radius (approximately 2 inches) the fiber can tolerate before signal loss becomes excessive. The typical size for an eight channel device is approximately 4 by 6 inches by 0.5 inches thick. Mux/de-mux devices having sixteen or more channels are only slightly larger, fiber management still being the major issue.

What is needed is a highly efficient mux/de-mux device that is smaller and more economical than current devices. A smaller format would result from the elimination of internal fiber management and fiber-to-fiber splices between the wavelength selective elements, as well as a reduction in the number of components required for each channel. A smaller format device would occupy less space on circuit boards thus helping to reduce both the size and cost of optical networks.

### SUMMARY OF THE INVENTION

One of the features of the present invention is to provide a miniature optical mux/de-mux device for fiber optic communication systems, which will operate with either single-mode or multimode fiber optic cables.

Another feature of the present invention is to minimize optical losses at all component interfaces to produce a highly efficient device with better optical performance than current devices.

A further feature of the present invention is to provide a device with fewer components per channel than current devices in order to reduce the cost of the device.

Yet another feature of the present invention includes a novel design for the mux/de-mux device, which can be constructed by computer controlled robotic assembly to reduce labor costs.

Still another feature of the present invention is a simplified sealing system and mounting container, which thermally isolates the device and provides improved environmental protection.

Described below is the design and construction details of a miniature mux/de-mux, DWDM or CWDM device. Two embodiments of the design are discussed, one has a radial format and the other has a linear format; however, the operating principles of each are identical. The basic device is described using an eight-channel format as an example, but a fewer or greater number of channels are easily accommodated. Additionally, two or more of the devices may be linked together to provide additional channels either at initial installation or to expand the number of channels at a later date.

The present invention is comprised of a base plate, which serves as a miniature optical bench, and three types of free-space optical components, collimators, filters, and mirrors, that are mounted on the plate. A thinner top plate can be attached to each of the free-space optical components to strengthen the structure against mechanical shock. Half of the collimators are required in this architecture compared to current devices with the same number of channels. Fewer fiber-to-fiber splices and fiber-to-collimator couples reduce insertion losses. The assembled package is mounted in a small thin-walled container of similar shape, and it is thermally isolated from the container. Both the container and optical fibers are sealed following an established technique that is used in the insulated glass window industry. No adhesive or sealant obstructs the optical path.

The free-space optical components used in the device are fiber optic collimators similar to those previously described, thin film multi-cavity filters, and thin-film high reflectivity dielectric mirrors. Each optical component is actively aligned and secured in position before the next component is added. The insertion loss from channel to channel is primarily dependent on the divergence of the approximately parallel beam of light produced by the fiber optic collimator; however, no collimator is perfect. The present invention has a unique and novel way to adjust divergence of the collimator beam through curvature induced into the filter and mirror components by the coating stress, thus improving collimator and device performance.

The present invention is an optical wavelength multiplexer and de-multiplexer device, that includes a base plate having a surface, a first optical collimator mounted to the base plate surface for receiving multiwavelength light from an input optical fiber and producing a substantially collimated free-space beam of the light, a plurality of optical filters each mounted to the base plate surface for receiving the light beam, for transmitting any portion of the received light beam within a predetermined wavelength range, and for reflecting the untransmitted portion of the received light beam to another of the optical filters, wherein the predetermined wavelength range for each of the optical filters is different from that of the other optical filters, and a plurality of optical collimators each mounted to the base plate surface for focusing one of the transmitted portions of the light beam from one of the optical filters into one of a plurality of output optical fibers.

In another aspect of the present invention, the optical device for multiplexing and de-multiplexing multiwavelength light includes a base plate having a surface, a first optical collimator mounted to the base plate surface for receiving multiwavelength light from an input optical fiber and producing a substantially collimated free-space beam of the light, wherein the multiwavelength light includes a plurality of predetermined light channels each having a distinct predetermined range of wavelengths, a plurality of optical filters each mounted to the base plate surface for receiving the light beam, wherein each of the optical filters transmits one of the channels of the received light beam while reflecting the other channels of the received light beam to another of the optical filters, and a plurality of optical collimators each mounted to the base plate surface for receiving one of the channels of the light beam transmitted by one of the optical filters, and for focusing the received channel of the light beam into one of a plurality of output optical fibers.

In yet another aspect of the present invention, the optical device for multiplexing and de-multiplexing multiwavelength light includes a base plate having a surface, a first optical collimator mounted to the base plate surface for receiving multiwavelength light from an input optical fiber and producing a substantially collimated free-space beam of the light, wherein the multiwavelength light includes a plurality of predetermined light channels each having a distinct predetermined range of wavelengths, a first optical filter mounted to the base plate surface for receiving the light beam from the first optical collimator, wherein the first optical filter transmits one of the light channels of the received light beam while reflecting the other light channels of the received light beam, a second optical collimator mounted to the base plate surface for focusing the one light channel transmitted by the first optical filter into a first output optical fiber, a second optical filter mounted to the base plate surface for receiving the other light channels reflected by the first optical filter, and for reflecting the received other light channels, a third optical collimator mounted to the base plate surface for focusing the other light channels reflected by the second optical filter into a second output optical fiber, and a fourth optical collimator mounted to the base plate surface for receiving light from a second input optical fiber and producing a substantially collimated second free-space beam of the light, and for directing the second light beam through the second optical filter and to the third optical collimator for focusing into the second output optical fiber.

In yet one more aspect of the present invention, a method of multiplexing and de-multiplexing multiwavelength light includes the steps of collimating multiwavelength light emitted from an input optical fiber to form a free-space beam of the light, wherein the multiwavelength light includes a plurality of predetermined light channels each having a distinct predetermined range of wavelengths, reflecting the light beam off a plurality of optical filters, wherein each of the optical filters transmits one of the channels of the light beam while reflecting the other channels of the light beam, and focusing each of the channels of light transmitted by the each of the optical filters into one of a plurality of output optical fibers.

Other objects and features of the present invention will become apparent by a review of the specification, claims and appended figures.

### BRIEF DESCRIPTION OF THE DRAWINGS

FIG. 1A shows the construction of a conventional fiber optic collimator using a graded index (GRIN) lens.

FIG. 1B shows the construction of a conventional fiber optic collimator using a micro-aspheric lens.

FIG. 1C shows the construction of a conventional fiber optic collimator using a ball lens.

FIG. 2A shows a conventional 3-port module for separating one optical signal from an input containing a number of optical signals.

FIG. 2B shows a conventional 8-channel mux/de-mux architecture using a cascade of 3-port modules to successively separate individual optical signals from a plurality of input optical signals.

FIG. 3A shows a three-dimensional view of the basic radial embodiment of the present invention. The protective container is not shown.

FIG. 3B shows a three-dimensional view of the basic linear embodiment of the present invention. The protective container is not shown.

FIG. 4A is a plan view of the radial embodiment of the present invention showing the optical path and the positions of the optical components.

FIG. 4B is a plan view of the linear embodiment of the present invention showing the optical path and the positions of the optical components.

FIG. 5A is a plan view of the radial embodiment of the present invention showing a design variation for increasing the number of channels in the device.

FIG. 5B is a plan view of the linear embodiment of the present invention showing a design variation for increasing the number of channels to 16 in the device.

FIG. 6A is a plan view of the linear embodiment on the present invention showing a design variation for an 8-channel device.

FIG. 6B is a plan view of an add/drop device based on the linear architecture.

FIG. 7A is a plan view of the radial embodiment showing how channel count can be increased through serial connection.

FIG. 7B is a plan view of the radial embodiment showing how channel count can be increased by connection through band splitting filters.

FIG. 7C is a plan view of the radial embodiment showing how channel count can be increased by connection through skip or band isolating filters.

FIG. 8A is the theoretical transmission curve for a 100 GHz multi-cavity thin-film filter according to design A at an angle of incidence of 0 degrees.

FIG. 8B is the theoretical transmission curve for a 100 GHz multi-cavity thin-film filter according to design B at an angle of incidence of 0 degrees.

FIG. 9A is the theoretical transmission curves for the S and P polarization components of a 100 GHz multi-cavity thin-film filter according to design A at an angle of incidence of 10 degrees.

FIG. 9B is the theoretical transmission curves for the S and P polarization components of a 100 GHz multi-cavity thin-film filter according to design B at an angle of incidence of 10 degrees.

FIG. 10 shows the difference in transmission between the S and P polarization components of a 100 GHz multi-cavity thin-film filter according to design A for angles of incidence between 0 and 10 degrees.

FIG. 11 is a cross-sectional schematic view of the radial or linear device with the cross section taken approximately along the light path from a mirror to a filter and into a collimator.

FIG. 12A is an enlarged cross-sectional schematic showing the normal curvature of a filter and mirror caused by intrinsic stress in the coating.

FIG. 12B is an enlarged cross-sectional schematic showing the preferred method of compensating the effects of normal curvature by coating the mirror on its rear surface.

FIG. 12C is an enlarged cross-sectional schematic showing an alternative method of compensating the effects of normal curvature by identical coatings on each side of the filters and mirrors.

FIG. 13A is a plan view showing the bottom protective housing for the radial device.

FIG. 13B is a plan view showing the top protective housing for the radial device.

FIG. 14A is a plan view showing the bottom protective housing for the linear device.

FIG. 14B is a plan view showing the top protective housing for the linear device.

FIG. 15A shows the radial device assembled into the bottom protective housing.

FIG. 15B shows the linear device assembled into the bottom protective housing.

FIG. 16 is a cross-sectional schematic view of the fully assembled radial or linear device.

FIG. 17A is a plan view of the radial embodiment of the present invention with a single, arcuate shaped mirror with flat mirror facet portions.

FIG. 17B is a plan view of the linear embodiment of the present invention with a single, elongated mirror.

### DETAILED DESCRIPTION OF THE PREFERRED EMBODIMENTS

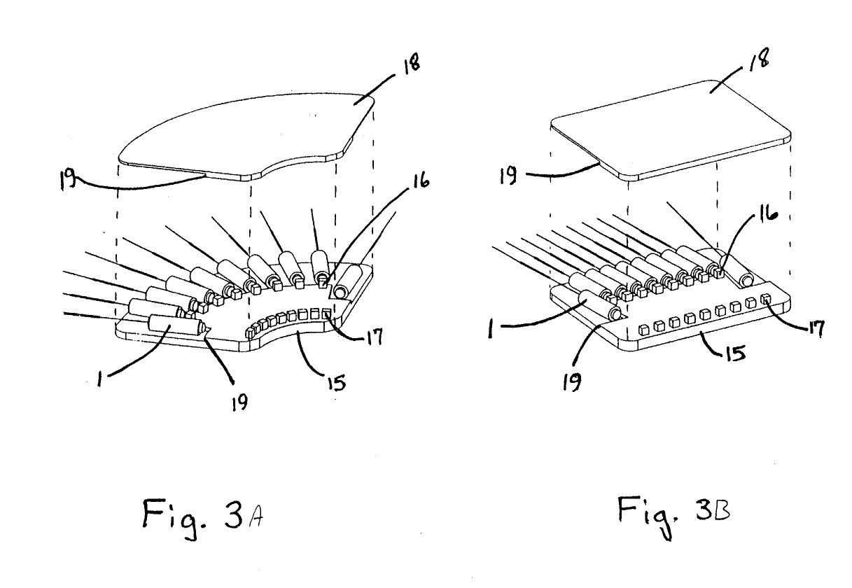

FIGS. 3A and 3B are three-dimensional views of the two basic embodiments of the present invention. Neither view shows the container into which the device is later sealed to provide both environmental protection, and a means to mount the device to a circuit board or other optical network platform. The container will be discussed after the core optical concepts are described. FIG. 3A illustrates the radial embodiment, while FIG. 3B illustrates the linear embodiment. Throughout this description it is primarily an 8-channel device that is used for purposes of illustration; however, those skilled in the art will readily understand how the basic geometry can be adapted for either a fewer or a greater number of channels. For example, the radial format in FIG. 3A subtends a 90-degree angular section of a circular annulus, but the angular section for a 4-channel device would subtend a smaller angle while a 16-channel device would require a larger angle. Similarly, the linear device in FIG. 3B would be shorter for fewer channels and longer for a greater number of channels. If reduced to just two channels, the linear embodiment might be more practical than the radial, since the mounting would become cumbersome. As a 2-channel embodiment, it would become a device to add or drop a channel (add/drop) to or from a signal stream. The functional principles are identical for either embodiment, only the format (radial or linear) differs to accommodate variations in available components and filter performance. One can consider the linear format to be simply the limit of the radial format at an infinite radius.

The description below includes numerical values for the component design, orientation and size of the preferred embodiments of the present invention, which were obtained by reducing the preferred embodiments to practice. However, it should be understood that these numerical values are included as examples only, and do not limit the scope of the invention.

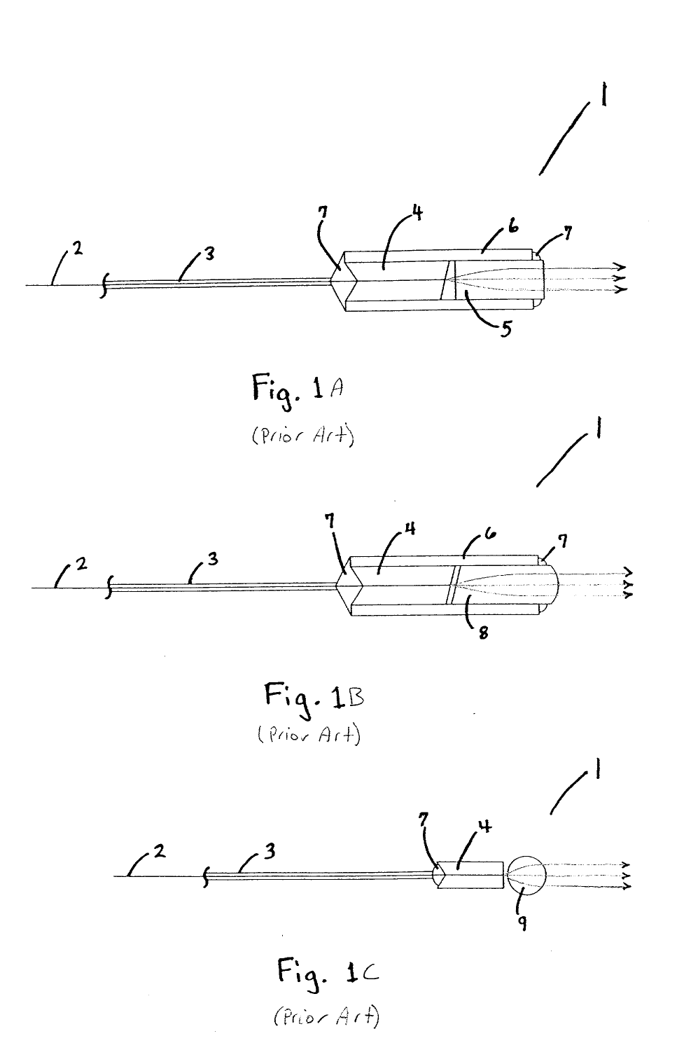

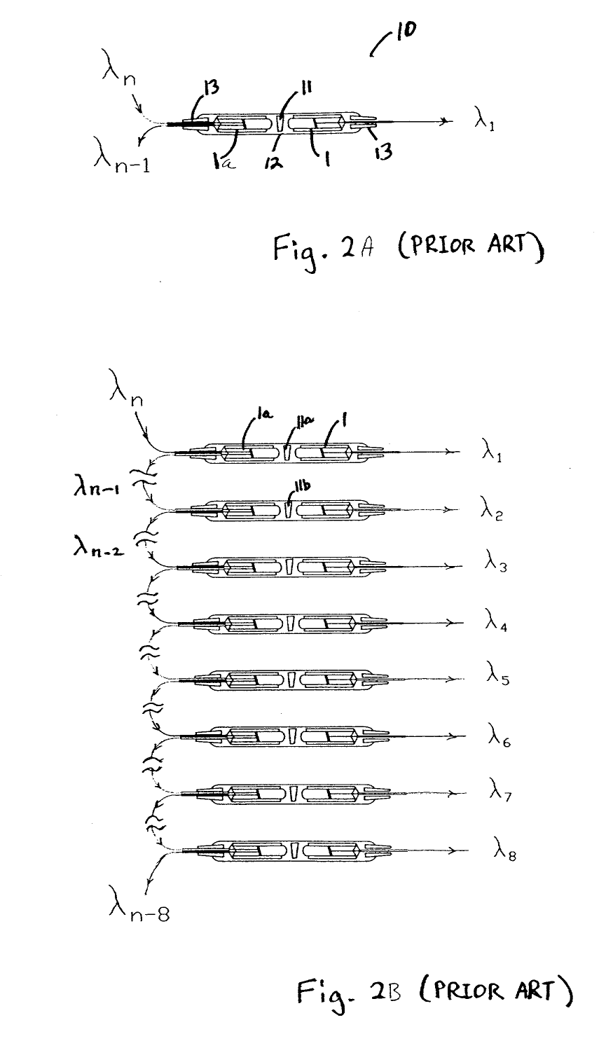

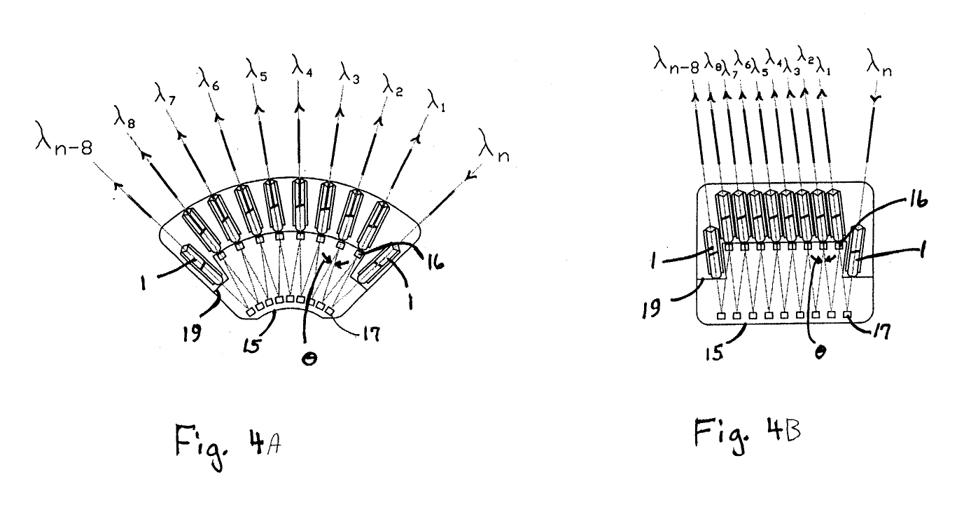

Each embodiment has a base plate 15 with at least a flat upper surface that serves as a miniature optical bench. Its thickness is selected for stability depending on the material used. For example, a typical thickness for glass or silicon is 3 to 4 mm. Fiber optic collimators 1, multi-cavity thin-film filters 16 and thin-film high reflectivity dielectric mirrors 17 are mounted on plate 15 using adhesives that are compatible with the physical properties of the materials. Fiber optic collimators 1 can be any of the three fiber collimators illustrated in FIGS. 1A, 1B or 1C, or any other optical device that collimates the optical output of an optical fiber (and focuses collimated light into an optical fiber in a reverse direction). Filters 16 are industry standard Fabry-Perot multi-cavity type coated optics, made of alternating layers of transparent high and low index dielectric materials formed on a transparent substrate. Cavities are formed by the inclusion of transparent layers of material. Mirrors 17 are similarly well known optics made of alternating layers of transparent high and low index dielectric materials mounted on a substrate, but contain no cavities. While a silver or gold mirror would work in this application, the reflection therefrom is somewhat inferior to the dielectric mirror described above. In the radial embodiment shown in FIG. 4A, the filters 16 (along with the collimator 1) and the mirrors 17 are disposed in opposing arcuate patterns of differing radii of curvature. In the linear embodiment shown in FIG. 4B, the filters 16 (along with the collimator 1) and the mirrors 17 are disposed in opposing columns.

Top plate 18 is secured to the top of each optical component by an adhesive in similar fashion to the way they are attached to the base plate. The top plate is thinner than the base plate to minimize the overall device thickness, but it is thick enough to provide a sandwiched structure that is resistant to shock and vibration. Typically its thickness is about 1 mm for glass or silicon. In general both the base plate and the top plate can have a ledge or step 19 which is sized to bring the axes of the particular fiber collimators in line with the centers of the filters and mirrors. If the diameters of the collimators and the heights of the filters and mirrors are equal, step 19 can be eliminated. If the collimators were smaller in diameter than the filter dimension (opposite to that shown in the figures), then step 19 would be in the opposite sense.

Invariably there are trade-offs that must be made between minor variations in the design and their impact on the cost. For example, if the diameter of the optimum collimator that is available is greater than the height of a standard filter, one could either create the step in the base and top plates or increase the size of the filter. Since each filter is expensive, and increasing its size increases both its cost and the total thickness of the device, the more cost effective approach is to create the step in the plates. In addition, if adhesive in the optical path could be tolerated for low laser power systems, then filters 16 could be attached directly to the end of collimators 1. GRIN type collimators would serve best for this purpose since their ends are flat. This would have the advantage of being a pre-assembled part, but GRIN type collimators can be more expensive, and adhesive in the optical path is not broadly acceptable.

FIGS. 4A and 4B are schematic plan views of the radial and linear embodiments of the device showing the base plates with the layout of the optical components and the light paths through each device. The top plates seen in the previous figures are not shown. Elements common to previous drawings are labeled with consistent numerical designations. Arrows on the fibers indicate an input of signals from an incoming fiber optic cable that are formed into a parallel beam by a first optical collimator 1. Subsequently mirrors 17 and filters 16 reflect the parallel beam through the device in a linear or arcuate zigzag pattern with eight of the n input channels being separated out (de-muxed), each separated channel being refocused back onto an output fiber optic cable by another optical collimator 1. If the arrows were each turned around, it would indicate eight different laser signals being combined or muxed onto a single optical fiber. A last port, λₙ₋₈, can be used, if required, to pass unused channels through the device for use elsewhere. In general the same device can be used in either direction depending upon which way it is hooked up. For purposes of simplification the de-mux form of the device is used in this description. In addition, the radial format is described as a 90-degree segment, but as explained before that is not an essential feature of the design, although it is a possible convenience for mounting in the corner of a circuit board.

The radial and linear devices in FIGS. 4A and 4B respectively are shown at the same relative linear scale to facilitate direct comparison. The actual length of an 8 channel linear device is approximately 1.5 inches. Each device is illustrated using exactly the same components, so the differences and relative advantages of the formats can be compared. If, for the same number of channels, one requires the total length of the optical path to be approximately the same in each format (from the input fiber collimator at λₙ through the “hall of mirrors” to the output pass through collimator at λₙ₋₈), then the input collimators are identical and have the same working distance in each format. As mentioned earlier, fiber collimators are becoming commercially available with working distances in the range of 200 mm and with diameters below 3 mm. They will become smaller as the state of the technology advances, enabling the size of the present devices to be reduced further. Given these constraints, it should be apparent from the figures that the radial embodiment is limited in its size by the crowding together of high reflection mirrors 17 along their mounting arc, while the linear embodiment becomes limited by the crowding together of fiber collimators 1. The linear format has the advantage of somewhat smaller size, but the radial format allows more working room for collimator alignment and it has a smaller angle of incidence (AOI) of the beam at filters 16. The angle θ in the radial format is 10.8 degrees, while θ in the linear format is 14 degrees. The AOI of the beam is half of each angle, or 5.4 degrees in the radial format and 7 degrees in the linear format. A smaller AOI is advantageous from the standpoint of filter design, as will be discussed below.

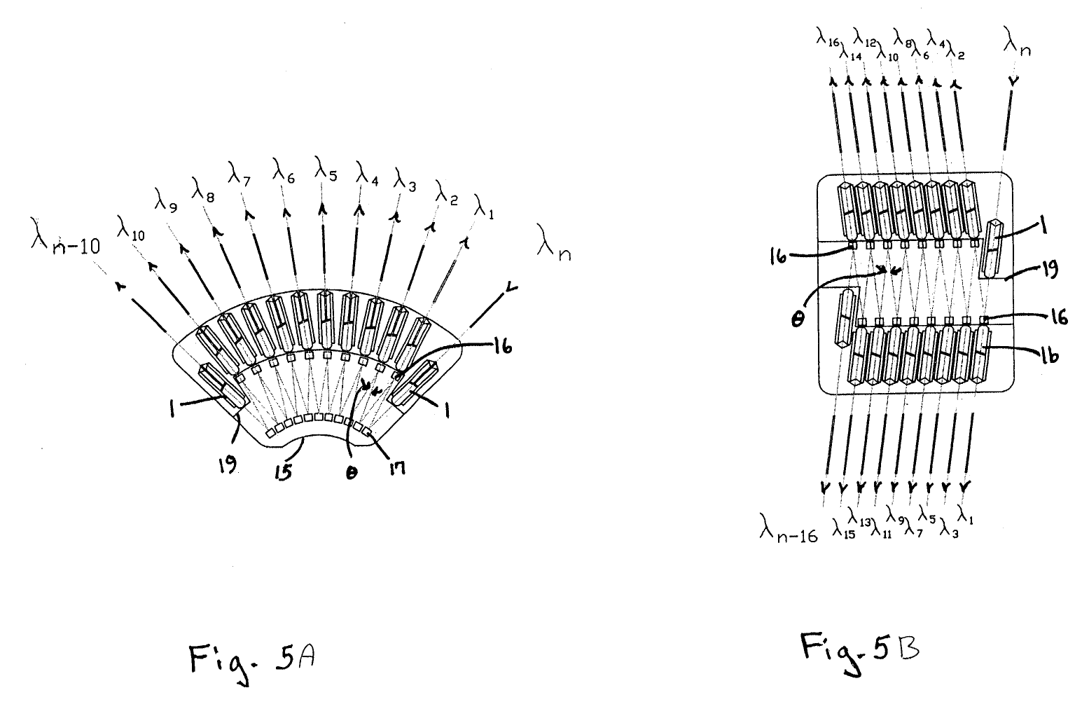

FIG. 5A illustrates the design variation caused by increasing the channel count from eight to ten in the radial format while keeping the same base plate as that shown in FIG. 4A. Collimators 1 and filters 16 are closer together than in the 8-channel case, but there is still adequate space to allow robotic manipulation and alignment of the components for manufacturing the device. Keeping the AOI the same as before (angle θ equal to 10.4 degrees) requires that mirrors 17 be aligned along an arc of slightly larger radius. The longer arc still does not accommodate the room needed for the two extra mirrors for the additional two channels, so the mirror crowding becomes worse. If more channels were added in the same footprint, the mirrors would first touch and then either overlap or have to be made smaller. It is probably more cost effective to avoid customized sizes of the optical components, and adjust the footprint of base plate 15 to accommodate devices with different channel counts. The component layout formats shown in FIGS. 4A and 4B are deemed to be a good compromise between standard component sizes, design flexibility, and the requirements for robotically controlled alignment.

One way to increase the channel count in the linear format is simply to make it longer and add collimators at the same spacing as shown in FIG. 4B. For example a 16-channel device would be a little less than twice as long as the 8-channel device, but the last channel would suffer the combined reflection loss from sixteen mirrors and fifteen filters. This creates a larger difference in signal strength between the first and the last channel for the 16-channel device compared to the 8-channel device. Some of the signal difference can be avoided by the design shown in FIG. 5B. This 16-channel layout avoids the loss from the mirror reflections by replacing the mirrors 17 in FIG. 4B with filters 16, and adding collimators 1b for the extra eight channels. For mirrors with 99.5% reflection, the reduction in signal variation across the sixteen channels is about 0.35 db. Angle θ remains the same at 14 degrees (AOI of 7 degrees). This layout results in the odd numbered channels being de-muxed on one side of the device, and the even channels de-muxed on the other side of the device. An advantage of this layout is that the same collimator working distance can now serves sixteen channels instead of eight. Possible disadvantages are its departure from the current architecture of having all of the ports on one side, and the loss of a degree of freedom in alignment that may improve production yields. Of course one could restore all of the output fibers to the same side of the container by bending the eight outputs on one side around to the other side. While this would increase the size of the container, it would still reduce costs and improve performance when compared to current technology. Because filters become better reflectors at wavelengths further from their pass bands, the difference in signal loss between the channels is minimized by de-muxing the channels in wavelength (or frequency) order.

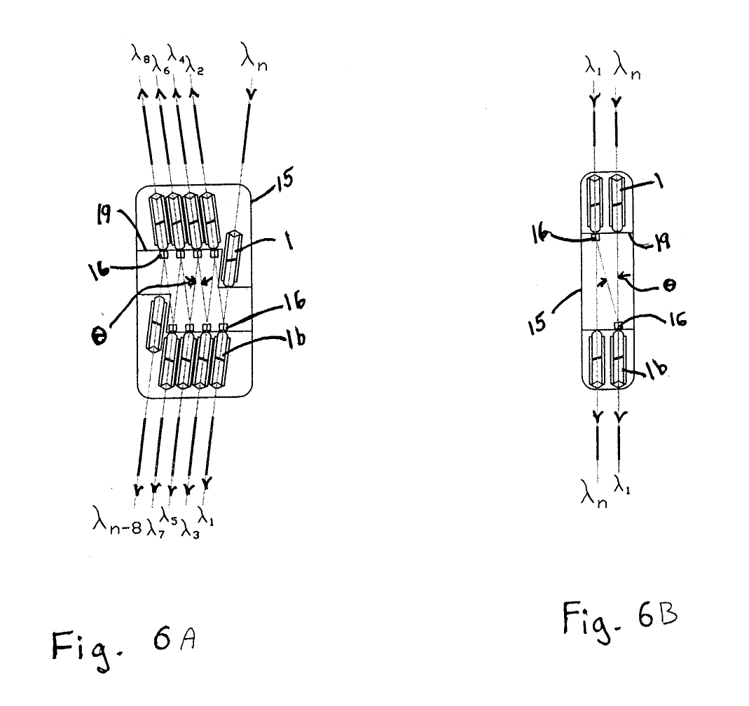

If the basic 8-channel linear device that is shown in FIG. 4A is laid out in the same way as that described for the extended channel device shown in 5b, the 8-channel device illustrated in FIG. 6A is the result. The angle θ is still 14 degrees as in the previous examples. Now the number of reflections is eight instead of sixteen, leading to a reduction in the variation of signal strength across the eight channels of less than 0.2 db. This small level of improvement in the variation of the signal strength of the channels is perhaps not enough to offset the disadvantages of having the ports on two sides, and the loss of a degree of freedom for aligning the components.

FIG. 6B shows the smallest practical device that could be made using the present architecture. It is an “add/drop” device used to mux (add) and de-mux (drop) a single channel. The angle θ of 14 degrees is preserved in this device as it was in the other linear devices. An input signal consisting of λₙ different input channels is fed into the device where a first filter 16 separates out one channel (λ₁ for example) and reflects all others to a second filter 16. Most commonly this second filter is identical to the first, i.e. it passes channel λ₁; although, it need not be identical so long as it is different for any of the other λₙ input signals. In the figure a laser source is used to add data on channel λ₁ back into the signal stream, so that λₙ signals emerge from the device. The net effect is that the original data on channel λ₁ has been dropped from the input signal stream, but new (different) data on channel λ₁ has been added to the output signal stream.

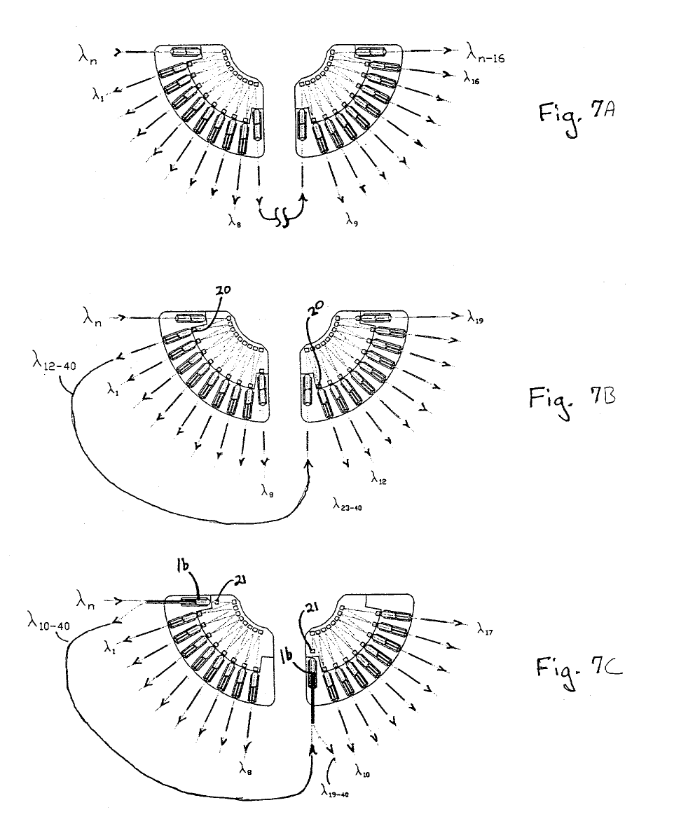

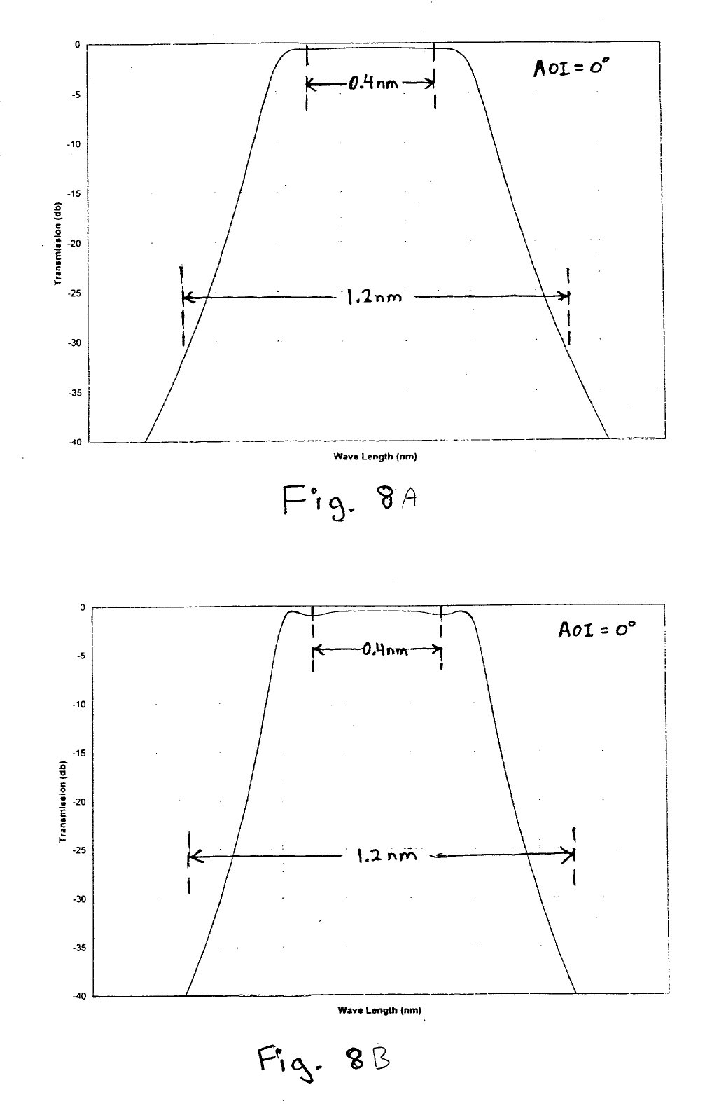

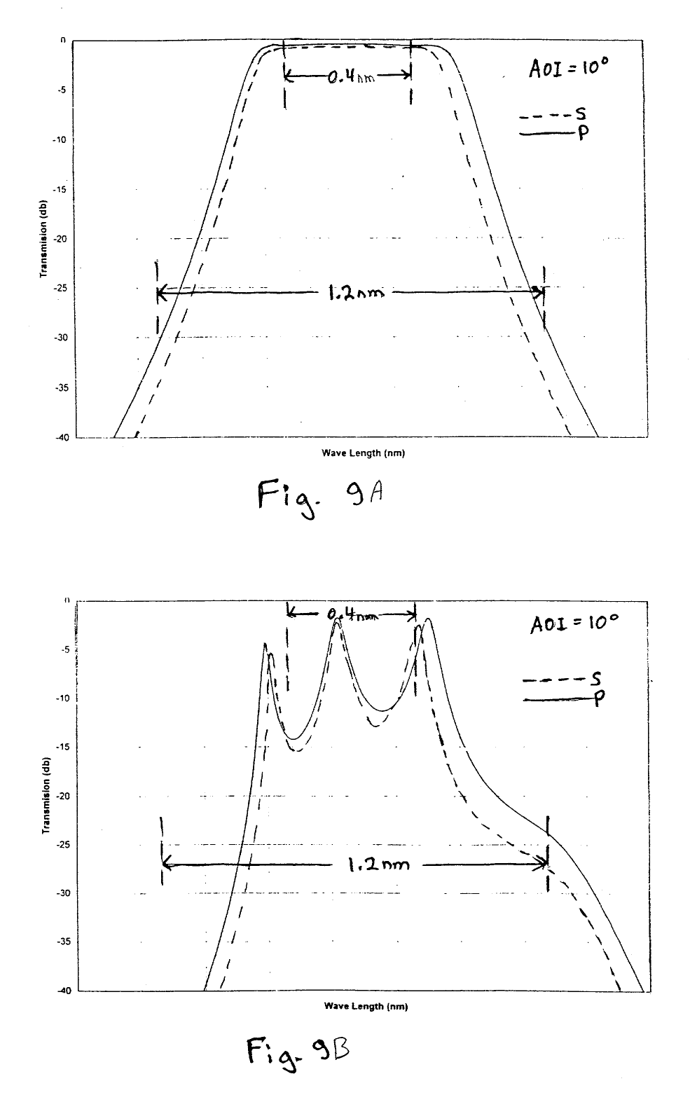

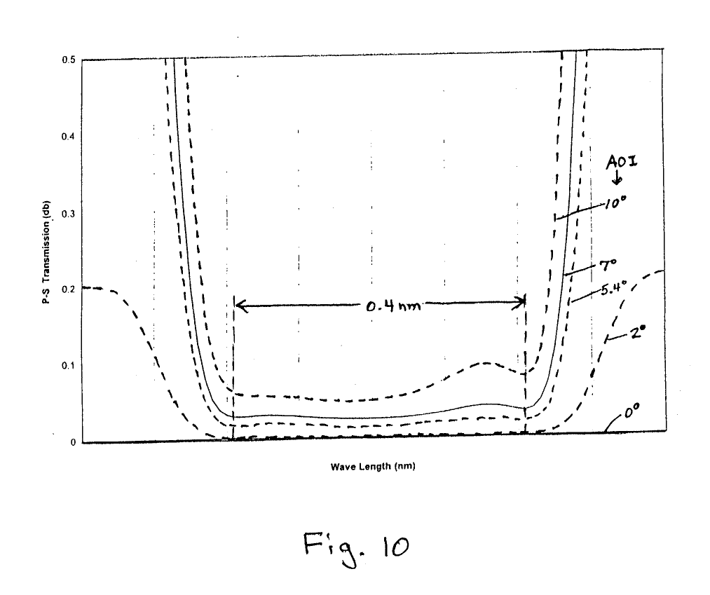

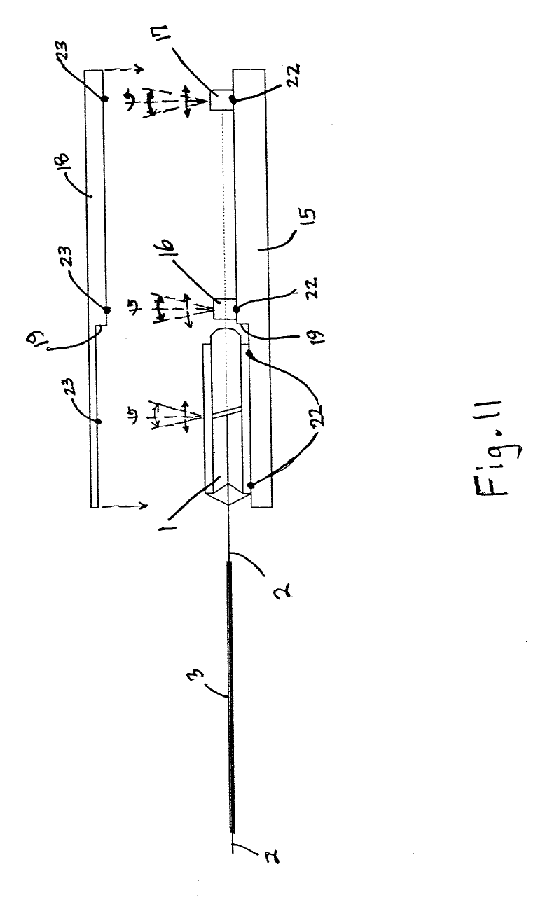

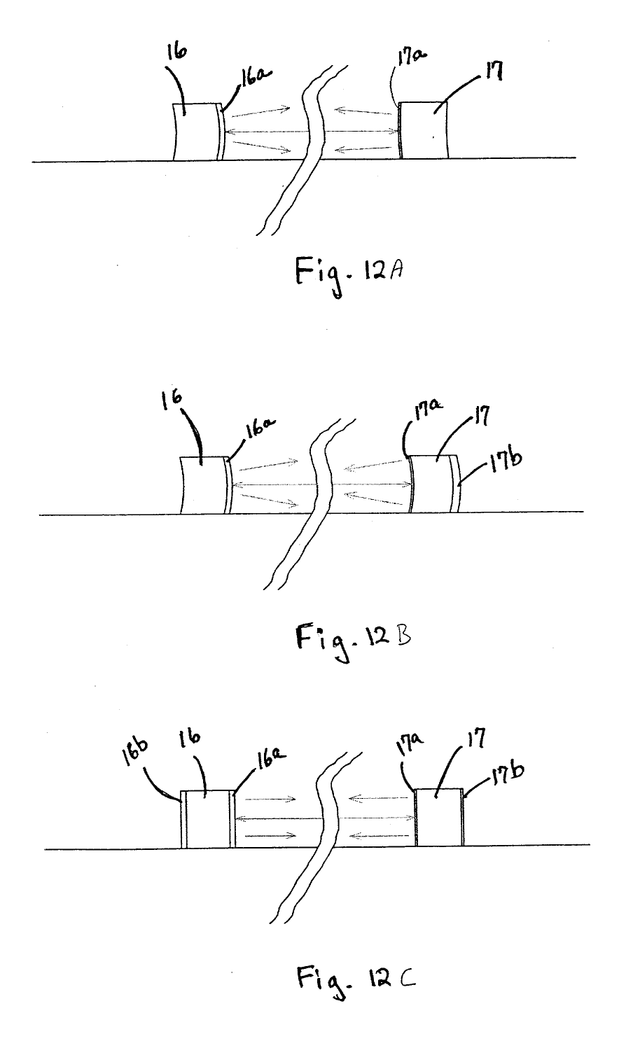

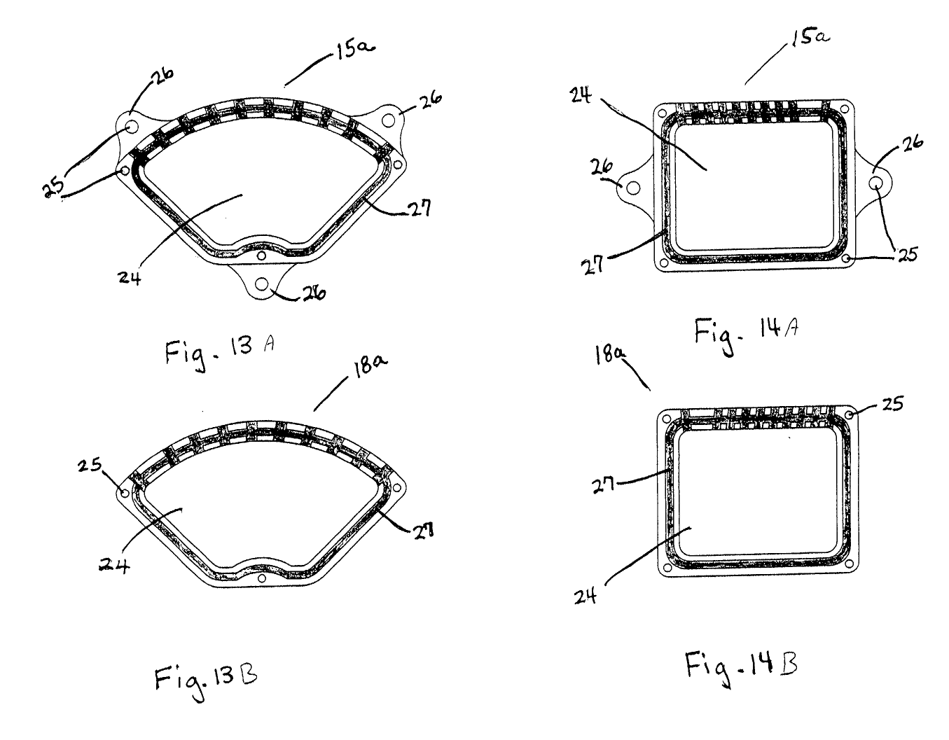

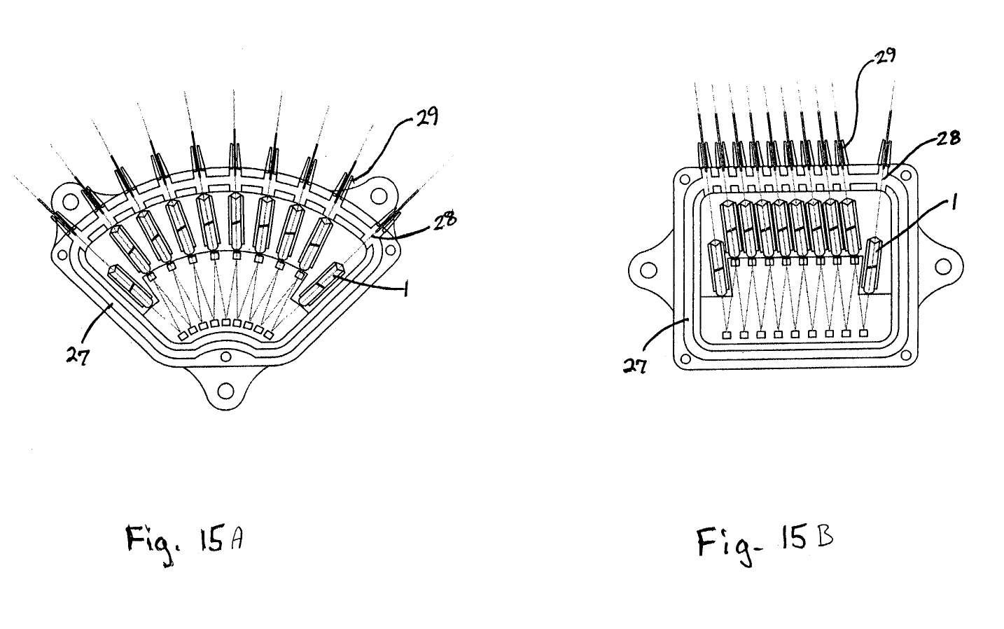

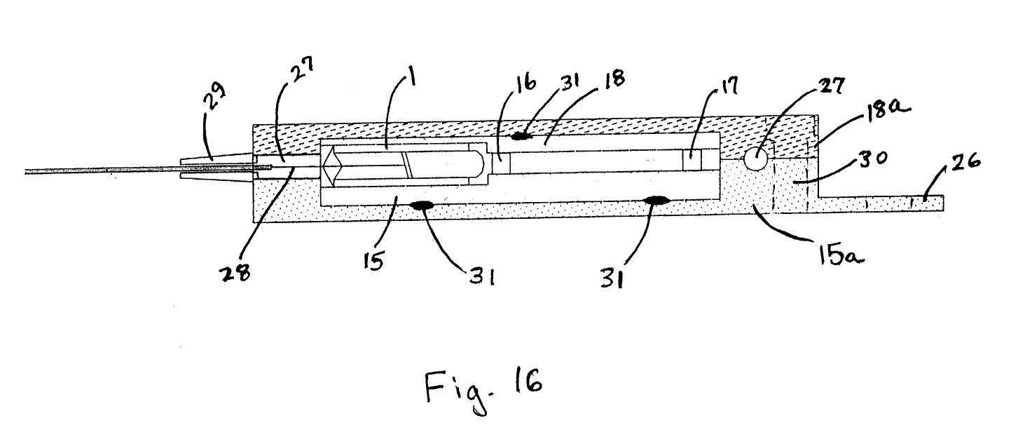

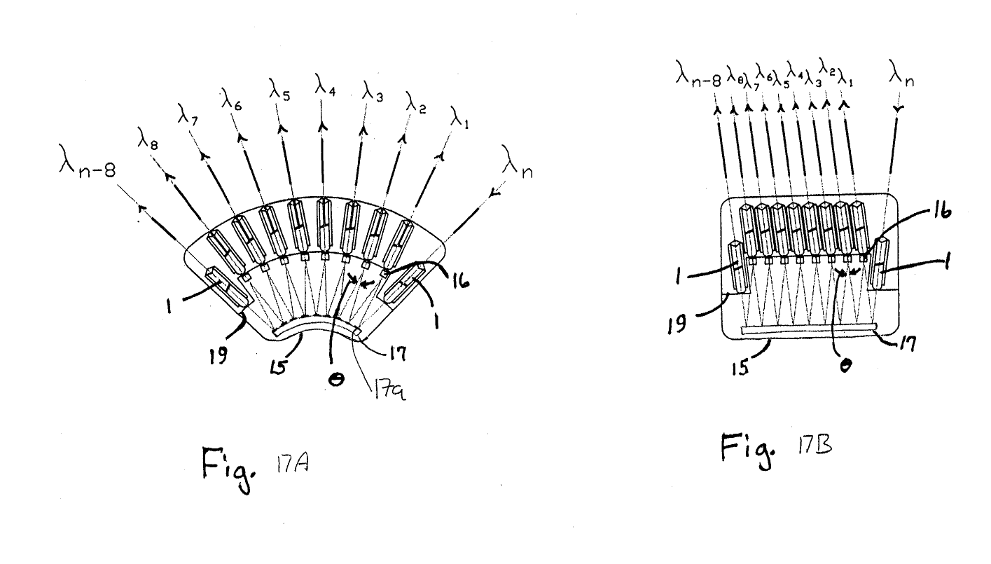

The preferred way to increase the channel count is to use a device of standard format (8 channels for example), and connect or cascade one device to a second and even a third or a forth device. This method has the advantage of a standardized basic platform for reduced manufacturing costs, while allowing later expansion when the need arises. FIGS. 7A, 7B, and 7C illustrate three ways that the channel count can be increased from eight to sixteen channels using the basic radial format as an example. Although not shown for convenience, the linear format can be expanded following exactly the same principals and procedures.

The first way the channel count can be increased is to connect the devices together serially. FIG. 7A shows two of the radial devices in FIG. 4A being connected together in this way. The last (pass-through) channel of the first device is used as the input to the second device to increase the de-muxed channel count to sixteen. The pass-through channel of the second device (λₙ₋₁₆) could in turn become the input to a third device, etc. Serial connection has the advantage of simplicity, but the signal for the last de-muxed channel has suffered reflection from all the other components ahead of it, while the first de-muxed channel has suffered only one reflection. This leads to the greatest difference between output signal strengths, or the greatest difference in insertion loss, across the band of de-muxed signals. To equalize the outputs, all the channel signal strengths must be reduced to the level of the last (lowest) one.

A second way of connecting the devices to increase channel count is shown in FIG. 7B. It uses a band splitting filter 20 in its first filter position. The other eight channel filters are each shifted one position so that the previous pass-through position now has an individual channel filter and becomes the last de-muxed channel. The band splitting filter has the property that it reflects the first eight channels to be de-muxed in the first device, and (ideally) transmits all of the rest. In reality it is very difficult to make such a wide filter with such a steep cut between channels, so a more practical filter is illustrated in the figure, i.e. passing only channels 12 through 40 as an example. Channels 9, 10, and 11 are “skipped” because of the filter shape. The signal output from the band splitting filter is used as the input to a second similar device, which has a band splitting filter for channels 23 through 40 in its first filter position. The sixteenth channel that is de-muxed (λ₁₉) now has less insertion loss than the sixteenth channel in the previous serial example because it has suffered only half of the reflection loss. The output signal (λ₂₃₋₄₀) from the band splitting filter of the second device could be input to a third, and that into a fourth device.

A third way of connecting the devices to increase the channel count is shown in FIG. 7C. This method utilizes a 2-port collimator 1a, like that described in FIG. 2A of the prior art. Filter 21 is a band isolating or “skip” filter. The technique is illustrated assuming an 8-skip-1 filter which passes eight channels but skips the one on each side of its band pass (0 and 9 in the first case). Ideally an 8-skip-0 would be preferred, but at present they are much more expensive and very difficult to produce. The eight channels passed by filter 21 are de-muxed in the next eight positions in the first device, and the remaining unskipped channels, 10 through 40, are reflected from filter 21 and collected at the second port of collimator 1b. These become the input to a second similar device, where a second 8-skip-1 filter 21 passes eight more channels (10 to 17) to be de-muxed. The reflected channels, 19 through 40 could be sent to a third similar device.

Adding filter 21 at the first collimator position, results in saving the cost of one collimator in the 8-channel device, since the last position that was used in the previous examples is now empty. As in the example shown in FIG. 7B, the last de-muxed channel has had fewer reflection losses, and therefore less insertion loss, than the serially connected devices of FIG. 7A. While the above examples used 8-channel devices for purposes of illustration, it is clear that the identical architecture could be accomplished using smaller 4-channel devices if the need arises. Devices of the present invention for DWDM use cannot be made arbitrarily smaller by increasing the AOI of the light path at the filters. The reasons for this will become clear from the following explanation. Consider first the transmission curves of the two 100 GHz 5-cavity filters illustrated at the same scale in FIGS. 8A and 8B. Both transmissions are calculated for an AOI of 0-degrees. The industry standard pass band of 0.4 nm and stop band of 1.2 nm at −25 db down from the transmission peak are marked in each figure. The filter in FIG. 8A is labeled Design A and that of FIG. 8B is Design B, and both represent different filter coating designs using quarter-wave mirror layers and half-wave cavity layers. For an AOI of 0-degrees (and small angles around 0 degrees), there is no essential difference in the S and P states of signal polarization, however the filter in FIG. 8B has the advantage of a sharper cutoff in the stop band, which better reduces interference from adjacent channels.

FIGS. 9A and 9B illustrate how markedly different the situation is when the AOI is increased to 10-degrees. Now the S (dashed) and P (solid) polarization components are significantly different from each other in both designs; however, the transmission shape of the filter in Design B has become totally unacceptable, while the filter in Design A still meets the standard specifications on pass band and stop band widths for each polarization component. The point here is not the differences in the filter designs. Any good computer optics code will predict that Design A type filters are superior when increasing the angles of incidence. The important point is that even the most optimum filter design has its limitations.

FIG. 10 shows the difference in transmission in db between the S and P polarization components as a function of wavelength for Design A type filters between 0 and 10-degrees AOI. This difference in transmission is called Polarization Dependent Loss (PDL), and the normal specification is that it must not be greater than 0.1 db in the pass band. FIG. 10 shows that this limit is essentially reached at an AOI of 10-degrees, and additionally, there is little manufacturing margin left for wavelength tolerance on the filter band pass center. The clear conclusion is that a mux/de-mux device for 100 GHz channel spacing (DWDM) cannot be made smaller by increasing the AOI beyond 10 degrees, and in fact 10 degrees allows little if any manufacturing margin. In the foregoing radial and linear designs the angles of incidence of 5.4 and 7 degrees are comfortably situated for the DWDM tolerances suggested in FIG. 10. For closer channel spacing, 50 GHz for example, the situation gets worse, meaning that the largest tolerable AOI is less than 10 degrees. For wider channel spacing (CWDM) the corresponding filters have pass bands that can be more than an order of magnitude wider than in DWDM. This allows CWDM devices to utilize filters with angles of incidence in the range of 13 to 14 degrees before the PDL becomes intolerable.

FIG. 11 is a schematic cross-sectional view representing either the radial or linear device. The cross section is taken along the light path from a mirror 17 to a filter 16 to a collimator 1. The components are labeled with numerical designations consistent with those used in preceding figures. Glass is the preferred material from which to fabricate the components since it is important to match their coefficients of thermal expansion. Materials other than glass are not excluded, for example, some types of stainless steel and invar have expansion coefficients close to glass. Bottom plate 15 functions as a miniature optical bench on which collimators 1, filters 16, and mirrors 17 are mounted. The sets of arrows above each of these components indicate that the robotic tooling has the freedom to translate the component slightly, tilt it back and forth, and rotate it about an axis to bring it into perfect optical alignment. A small translation of the component results in a small change in the AOI, which is within tolerances previously described. Because of this allowable tolerance in the AOI the filter can be slightly rotated to tune it to the exact channel wavelength, thus building in some tolerance in the filter manufacture. Black dots labeled 22 indicate the locations for the placement of small drops of adhesive for securing the components to the bottom plate. This adhesive should set solid and match the coefficient of thermal expansion of the glass components as closely as possible. It should be curable by UV or thermal energy or both. The adhesive should form a thin meniscus that supports the component without allowing direct glass-to-glass contact. Beginning with the first collimator each component is sequentially aligned and adhered in place. When all of the components are secured to base plate 15, top plate 18 is then attached to each component with a small drop of a different adhesive. Another set of black dots labeled 23 on top plate 18 indicate the location for the second adhesive, which does not set up solid but remains flexible. Securing the top plate in this fashion adds shock resistance to the part; however, it minimizes any thermally induced differential stress that could change the optical alignment of the components. As should be clear from the figures and description, there is no adhesive anywhere in the optical path.

One of the important factors influencing the insertion loss of each channel in the present device is the degree of accuracy in the collimation of the input signals. For the 8-channel device described here, the working distance of the first collimator should be about 200 mm to cover the total length of the optical path through the device. While collimators are readily available with stated working distances of this length, no lens surface is truly perfect, and there are minor variations from part to part. These lens aberrations can result in collimated beams that are either slightly converging or diverging with respect to perfect parallelism. This situation can be largely corrected by the introduction of a small amount of optical power (i.e. curvature) in the filters and mirrors.

FIG. 12A shows an enlarged cross-sectional schematic of the optical path between a typical filter 16 and a mirror 17 in the device. In this illustration the actual coatings on the glass blocks that create the filters and the mirrors are designated as 16a and 17a respectively. Filter 16 has an anti-reflection coating on the side opposite the filter coating, but it is too thin to materially affect the physical shape of the filter, so it is not explicitly shown. The stress generated in depositing both coatings 16a and 17a is intrinsically compressive. This stress is sufficiently high that the glass substrate is bent slightly convex on the coating side, the filter more so than the mirror. As indicated by the arrows in the figure, this small amount of negative optical power in the reflective filters and mirrors would cause an otherwise parallel beam to begin to diverge. Over the total length of the optical path, the collimated beam encounters this condition eight times for the filters and eight times for the mirrors in the 8-channel device described. In total this is an unacceptable amount of beam divergence. Of course if the input collimated beam were slightly converging, then the normally curved condition of the of the filters and mirrors in the device would tend to correct the convergence.

FIG. 12B illustrates the preferred way to make the curvature effects in the filters and mirrors cancel each other out so that no net optical convergence or divergence is added to the original collimated beam, which for this illustration is assumed to be perfectly parallel. The remedy is to add a coating 17b to the side of the mirror opposite to the reflective side 17a. Since light does not pass through the mirror, the additional coating does not have to have any specific optical properties, making it easier to produce. This coating compensates the curvature of the mirror to be equal and opposite that of the filter. The arrows indicate that the divergence added to the beam by reflection off of a filter is compensated exactly by the convergence added to the beam by its reflection off of a mirror. It is relatively straightforward with the sophistication of modem coating technology to achieve this cancellation with a very high degree of precision. In addition, if a small amount of net convergence or divergence is needed, it can be engineered in just by adjusting the thickness of coating 17b on the reverse side of the relatively inexpensive mirror. In this way variations in the performance of the collimators may be corrected as the device is assembled without adding significantly to the cost of the device.

A second way to cancel the effects of curvature in the filters and mirrors is illustrated in FIG. 12C. In concept this is the trivial solution, just put the same coating on one side of the component as on the other. While this is a simple solution for mirror 17 where coatings 17a and 17b are the same, it is rather complicated for the filter. Since the light signal for one channel must pass through the filter, coating 16b must not interfere with the transmitted signal. It could theoretically be identical to coating 16a, but the cost would be prohibitive. The practical solution here is for the coating to be a thick uniform layer of clear material that has a close index match to that of the substrate. Then one must add an anti-reflective coating that is designed to match the properties of the added layer. While simple in concept, this method is not as easy to implement in a manufacturing environment as that described in FIG. 12B, and it is much more expensive.

After the device is assembled and the optical alignment verified, it must be packaged in a protective container. A primary objective of the container is to keep moisture from getting into the device. Should this occur, a falling temperature would cause condensation on the optical surfaces, resulting in an unacceptable loss of optical signal. In addition, the container should provide a buffer to help protect the device from both mechanical and thermal shock. In the current state of the art most of the modules shown in FIG. 2A are hermetically sealed around each collimator with a solder joint. Solder sealing of the glass fiber itself is possible by first metallizing the fiber in the sealing area. While effective, this method is expensive, and it requires that some regions of the device withstand unusually high temperatures during the sealing process, which can result in misalignment of a previously well aligned device. The container in which a number of these modules are packaged to make a mux/de-mux device is usually O-ring sealed. The packaging method of the present invention is very effective, and it does not require elevated soldering temperatures or metallization of the glass fibers. The present invention borrows from techniques and materials that have been tested and proven in the insulated window glass industry.

An insulated glass unit (IGU) consists of two or more panes of glass separated by an extruded aluminum spacer that is slightly smaller than the size of the glass pane. In one sealing system a bead of isobutylene (butyl) is applied to each side of the spacer. Then the panes of glass are pressed against the spacer from either side. The butyl adheres well to both the aluminum spacer and the glass panes forming a waterproof seal that never fully hardens. The IGU is then held together mechanically with a polysulfide or polyurethane adhesive that fills a remaining gap all around the perimeter of the unit. A second kind of sealing system utilizes a thermally reactive type of butyl, which performs both the sealing and the mechanical joining functions in one application. Both types of seals remain intact through years of winter/summer and direct sun heating cycles and high humidity, similar to the conditions that must be endured by the mux/de-mux device.

The container for the radial device is shown in FIGS. 13A and 13B, and the container for the linear device is shown in FIGS. 14A and 14b. The preferred construction material is aluminum because of the forgoing discussion of sealing IGU's; however, several other metals or other materials, especially stainless steel, could be used. It is anticipated that manufacturing of the container in volume can be done by a metal casting process to substantially reduce machining costs. Each container is a symmetrical clamshell like structure consisting of bottom (15a) and top (18a) halves, the bottom half being somewhat thicker than the top half in proportion to the difference in thickness of the bottom and top plates of the device as previously described. The plan views are from the inside of the containers. The opposite sides (outside) are flat and featureless except for screw holes 25. Each half of the container has a recessed cavity 24 whose shape matches that of the device, but with enough clearance to prevent actual contact between the device (glass) and the container (aluminum). The bottom halves have thin protruding tabs 26 with holes for mounting the device to a circuit board or other network platform. Each half has a recessed channel 27 (shaded) in which the butyl seal is formed. While butyl or a form of butyl is the preferred sealant, other adhesives could be compatible with the design. Several epoxies and metal powder filled epoxies could probably be formulated to match the thermal expansion of the materials closely enough to seal without inducing excessive stress during temperature changes.

FIGS. 15A and 15B are top plan views of the radial and linear formats of the device, as they would appear when the devices (without top glass covers) are placed into the bottom half of their respective containers. FIG. 15A is a superposition of FIG. 4A onto FIG. 13A, and FIG. 15B is a superposition of FIG. 4B onto FIG. 14A. The bottom surfaces of base plates 15 of FIGS. 3A and 3B do not physically touch the recessed surfaces of cavities 24 of FIGS. 13A and 14A, rather they are thermally insulated from direct contact with the metal surface by a similar flexible adhesive to that described above in FIG. 11 for mounting top glass plate 18 to the tops of the optical components. A three point adhesive mount is acceptable for either format. The sealing of the unit around the glass fibers is the most challenging aspect of closing the container. In the present invention the fibers that emerge from collimators 1 are stripped to the glass cladding surface 28 so that the butyl in channel 27 will flow around and seal to the glass over a few millimeters of its length. Neither high temperatures nor metallization of the glass fiber is required. Stress relief boots 29 are placed around each fiber and retained at the edge of the device by an adhesive or a small slot that would be cast into the edge of the part.

FIG. 16 is a scaled schematic cross-sectional view of the assembled radial device. Elements in the figure carry numerical designations that are consistent with those used in previous figures. Except for the location of mounting tab 26, the figure is relatively correct for the cross-sectional view of the linear device as well. The basic device consists of base plate 15 and top plate 18 with the optical components mounted in between. The bottom half, 15a, and the top half, 18a, of the symmetrical clamshell container are held together by screws 30, while butyl seal 27 provides the moisture barrier between the metal surfaces and around glass fiber 28. The basic device does not physically touch the clamshell container in order to avoid a conductive heat transfer path that would create the potential for thermal shock. The device is mounted to the bottom half of the container by a thermally insulating flexible adhesive applied in spots indicated by black ovals 31. At least one such spot is included between the top half of the container and top plate 18 to improve the shock resistance of the device.

It is to be understood that the present invention is not limited to the embodiments described above and illustrated herein, but encompasses any and all variations falling within the scope of the appended claims. For example, mirrors 17 can be combined into a single mirror, as shown in FIGS. 17A and 17B. In the case of the radial embodiment (FIG. 17A), mirror 17 is a single, elongated, arcuate-shaped mirror, with planar mirror facets 17a for reflecting the light beam without spreading it in a plane parallel to base plate. In the case of the linear embodiment (FIG. 17B), mirror 17 is a single, planar, elongated mirror. It should be appreciated that although the above description refers to optical devices that produce a plurality of channel wavelengths which the present invention multiplexes and de-multiplexes, each of the channel wavelengths in fact includes a finite range of wavelengths, even channel wavelengths produced by narrow band optical sources.

What is claimed is:

1. An optical wavelength multiplexer and de-multiplexer device, comprising:
a base plate having a surface;
a first optical collimator mounted to the base plate surface for receiving multiwavelength light from an input optical fiber and producing a substantially collimated free-space beam of the light;
a plurality of optical filters each mounted to the base plate surface for receiving the light beam, for transmitting any portion of the received light beam within a predetermined wavelength range, and for reflecting the untransmitted portion of the received light beam to another of the optical filters, wherein the predetermined wavelength range for each of the optical filters is different from that of the other optical filters; and
a plurality of optical collimators each mounted to the base plate surface for focusing one of the transmitted portions of the light beam from one of the optical filters into one of a plurality of output optical fibers.

2. The optical device of claim 1, wherein none of the predetermined wavelength ranges overlap each other so that each of the optical filters extracts a distinct wavelength range portion from the light beam for focusing into one of the output optical fibers.

3. The optical device of claim 1, wherein secondary light beams exiting the output optical fibers are collimated by the optical collimators and directed via the optical filters to the first optical collimator for focusing the secondary light beams into the input optical fiber.

4. The optical device of claim 1, wherein the optical filters are disposed in a pair of opposing columns so that the light beam is serially reflected by the optical filters in a zigzag pattern.

5. The optical device of claim 4, wherein each of the optical collimators is disposed adjacent to one of the opposing columns of optical filters.

6. The optical device of claim 1, further comprising:
a plurality of mirrors each mounted on the base plate surface for receiving the light beam reflected by one of the optical filters and for reflecting the received light beam to another of the optical filters.

7. The optical device of claim 6, wherein the optical filters are disposed in a first column and the plurality of mirrors are disposed in a second column opposing the first column so that the light beam travels in a zigzag pattern as the light beam is reflected by the optical filters and the optical mirrors.

8. The optical device of claim 6, wherein the optical filters are disposed in a first arcuate pattern and the plurality of mirrors are disposed in a second arcuate pattern facing the first arcuate pattern so that the light beam travels in an arcuate zigzag pattern as the light beam is reflected by the optical filters and the optical mirrors.

9. The optical device of claim 8, wherein a radius of curvature of the first arcuate pattern is greater than that of the second arcuate pattern.

10. The optical device of claim 8, wherein the plurality of mirrors are integrally formed together as distinct planar facets of a unitary arcuate-shaped optical element.

11. The optical device of claim 1, further comprising:
an optical mirror mounted on the base plate surface for receiving the light beam reflected from each one of the optical filters and for reflecting the received light beam to another one of the optical filters.

12. The optical device of claim 11, wherein the mirror is elongated and the optical filters are disposed along a line facing the mirror so that the light beam travels in a zigzag pattern as the light beam is reflected by the optical filters and the optical mirror.

13. The optical device of claim 1, further comprising:
a top plate covering the base plate surface and attached to the first optical collimator, the plurality of optical filters, and the plurality of optical collimators by a flexible adhesive.

14. The optical device of claim 1, further comprising:
a coating formed on the optical filters for adjusting an optical power thereof via induced stress.

15. The optical device of claim 6, further comprising:
a coating formed on the mirrors for adjusting an optical power thereof via induced stress.

16. The optical device of claim 1, wherein the base plate is constructed of a low expansion glass material.

17. The optical device of claim 2, wherein a frequency separation between adjacent ones of the predetermined wavelength ranges does not exceed 100 GHz, and wherein each of the optical filters reflects the received light beam by no more than 20 degrees away from the received light beam.

18. The optical device of claim 1, further comprising:
a second base plate having a second surface;
a second optical collimator mounted to the second base plate surface for receiving light from one of the plurality of output optical fibers and producing a second substantially collimated free-space beam of the light;
a plurality of second optical filters each mounted to the second base plate surface for receiving the second light beam, for transmitting any portion of the received second light beam within a predetermined wavelength range, and for reflecting the untransmitted portion of the received second light beam to another of the second optical filters, wherein the predetermined wavelength range for each of the second optical filters is different from that of the other second optical filters; and
a plurality of second optical collimators each mounted to the second base plate surface for focusing one of the transmitted portions of the second light beam from one of the second optical filters into one of a plurality of second output optical fibers.

19. The optical device of claim 1, further comprising:
a band optical filter disposed in the light beam for reflecting a band of wavelengths of the light beam into an output optical collimator that focuses the band of wavelengths into a second output optical fiber;
a second base plate having a second surface;
a second optical collimator mounted to the second base plate surface for receiving the band of wavelengths from the second output optical fiber and producing a second substantially collimated free-space beam of the light;
a plurality of second optical filters each mounted to the second base plate surface for receiving the second light beam, for transmitting any portion of the received second light beam within a predetermined wavelength range, and for reflecting the untransmitted portion of the received second light beam to another of the second optical filters, wherein the predetermined wavelength range for each of the second optical filters is different from that of the other second optical filters; and
a plurality of second optical collimators each mounted to the second base plate surface for focusing one of the transmitted portions of the second light beam from one of the second optical filters into one of a plurality of third output optical fibers.

20. The optical device of claim 19, wherein the output optical collimator is integrally formed with the first optical collimator.

21. The optical device of claim 1, further comprising:
an output optical collimator that focuses the light beam into a second output optical fiber after the light beam has reflected off of the plurality of optical filters;

22. The optical device of claim 21, further comprising:
a second base plate having a second surface;
a second optical collimator mounted to the second base plate surface for receiving the light from the second output optical fiber and producing a second substantially collimated free-space beam of the light;
a plurality of second optical filters each mounted to the second base plate surface for receiving the second light beam, for transmitting any portion of the received second light beam within a predetermined wavelength range, and for reflecting the untransmitted portion of the received second light beam to another of the second optical filters, wherein the predetermined wavelength range for each of the second optical filters is different from that of the other second optical filters; and
a plurality of second optical collimators each mounted to the second base plate surface for focusing one of the transmitted portions of the second light beam from one of the second optical filters into one of a plurality of third output optical fibers.

23. An optical device for multiplexing and de-multiplexing multiwavelength light, comprising:
a base plate having a surface;
a first optical collimator mounted to the base plate surface for receiving multiwavelength light from an input optical fiber and producing a substantially collimated free-space beam of the light, wherein the multiwavelength light includes a plurality of predetermined light channels each having a distinct predetermined range of wavelengths;
a plurality of optical filters each mounted to the base plate surface for receiving the light beam, wherein each of the optical filters transmits one of the channels of the received light beam while reflecting the other channels of the received light beam to another of the optical filters; and
a plurality of optical collimators each mounted to the base plate surface for receiving one of the channels of the light beam transmitted by one of the optical filters, and for focusing the received channel of the light beam into one of a plurality of output optical fibers.

24. The optical device of claim 23, wherein each of the output optical fibers receives a different one of the channels of the multiwavelength light.

25. The optical device of claim 24, wherein light beams exiting the output optical fibers are collimated by the optical collimators and directed via the optical filters to the first optical collimator for focusing the light beams into the input optical fiber.

26. The optical device of claim 24, wherein the optical filters are disposed in a pair of opposing columns so that the light beam is serially reflected by the optical filters in a zigzag pattern.

27. The optical device of claim 26, wherein each of the optical collimators is disposed adjacent to one of the opposing columns of optical filters.

28. The optical device of claim 24, further comprising:
a plurality of mirrors each mounted on the base plate surface for receiving the light beam reflected by one of the optical filters and for reflecting the received light beam to another of the optical filters.

29. The optical device of claim 28, wherein the optical filters are disposed in a first column and the plurality of mirrors are disposed in a second column opposing the first column so that the light beam travels in a zigzag pattern as the light beam is reflected by the optical filters and the optical mirrors.

30. The optical device of claim 28, wherein the optical filters are disposed in a first arcuate pattern and the plurality of mirrors are disposed in a second arcuate pattern facing the first arcuate pattern so that the light beam travels in an arcuate zigzag pattern as the light beam is reflected by the optical filters and the optical mirrors.

31. The optical device of claim 30, wherein a radius of curvature of the first arcuate pattern is greater than that of the second arcuate pattern.

32. The optical device of claim 30, wherein the plurality of mirrors are integrally formed together as distinct planar facets of a unitary arcuate-shaped optical element.

33. The optical device of claim 24, further comprising:
an optical mirror mounted on the base plate surface for receiving the light beam reflected from each one of the optical filters and for reflecting the received light beam to another one of the optical filters.

34. The optical device of claim 33, wherein the mirror is elongated and the optical filters are disposed along a line facing the mirror so that the light beam travels in a zigzag pattern as the light beam is reflected by the optical filters and the optical mirror.

35. The optical device of claim 24, further comprising:
a top plate covering the base plate surface and attached to the first optical collimator, the plurality of optical filters, and the plurality of optical collimators by a flexible adhesive.

36. The optical device of claim 24, further comprising:
a coating formed on the optical filters for adjusting an optical power thereof via induced stress.

37. The optical device of claim 28, further comprising:
a coating formed on the mirrors for adjusting an optical power thereof via induced stress.

38. The optical device of claim 24, wherein the base plate is constructed of a low expansion glass material.

39. The optical device of claim 24, wherein a frequency separation between adjacent ones of the channels does not exceed 100 GHz, and wherein each of the optical filters reflects the received light beam by no more than 20 degrees away from the received light beam.

40. The optical device of claim 24, further comprising:
a second base plate having a second surface;
a second optical collimator mounted to the base plate surface for receiving the multiwavelength light from one of the output optical fiber and producing a substantially collimated second free-space beam of the light, wherein the multiwavelength light includes a plurality of second predetermined light channels each having a distinct predetermined range of wavelengths;
a plurality of second optical filters each mounted to the second base plate surface for receiving the second light beam, wherein each of the second optical filters transmits one of the second channels of the received second light beam while reflecting the other second channels of the received second light beam to another of the second optical filters; and
a plurality of second optical collimators each mounted to the second base plate surface for receiving one of the second channels of the second light beam transmitted by one of the second optical filters, and for focusing the received second channel of the second light beam into one of a plurality of second output optical fibers;
wherein each of the second output optical fibers receives a different one of the second channels of the multiwavelength light.

41. The optical device of claim 23, further comprising:
a band optical filter disposed in the light beam for reflecting a predetermined number of the light channels into an output optical collimator that focuses the predetermined number light channels into a second output optical fiber;
a second base plate having a second surface;
a second optical collimator mounted to the base plate surface for receiving the predetermined number of light channels from the second output optical fiber and producing a substantially collimated second free-space beam of the predetermined number of light channels;
a plurality of second optical filters each mounted to the second base plate surface for receiving the second light beam, wherein each of the second optical filters transmits one of the predetermined number of light channels of the received second light beam while reflecting the other of the predetermined number of light channels of the received second light beam to another of the second optical filters; and
a plurality of second optical collimators each mounted to the second base plate surface for receiving one of the predetermined number of light channels of the second light beam transmitted by one of the second optical filters, and for focusing the received one of the predetermined light channels into one of a plurality of third output optical fibers;
wherein each of the third output optical fibers receives a different one of the predetermined number of light channels.

42. The optical device of claim 41, wherein the output optical collimator is integrally formed with the first optical collimator.

43. The optical device of claim 23, further comprising:
an output optical collimator that focuses the light beam into a second output optical fiber after the light beam has reflected off of the plurality of optical filters;

44. The optical device of claim 43, further comprising:
a second base plate having a second surface;
a second optical collimator mounted to the base plate surface for receiving the light beam from the second output optical fiber and producing a substantially collimated second free-space beam of the light, wherein the multiwavelength light includes a plurality of second predetermined light channels each having a distinct predetermined range of wavelengths;
a plurality of second optical filters each mounted to the second base plate surface for receiving the second light beam, wherein each of the second optical filters transmits one of the second channels of the received second light beam while reflecting the other second channels of the received second light beam to another of the second optical filters; and
a plurality of second optical collimators each mounted to the second base plate surface for receiving one of the second channels of the second light beam transmitted by one of the second optical filters, and for focusing the received second channel of the second light beam into one of a plurality of third output optical fibers;
wherein each of the third output optical fibers receives a different one of the second channels of the multiwavelength light.

45. A method of multiplexing and de-multiplexing multiwavelength light, comprising the steps of:
collimating multiwavelength light emitted from an input optical fiber to form a free-space beam of the light, wherein the multiwavelength light includes a plurality of predetermined light channels each having a distinct predetermined range of wavelengths;
reflecting the light beam off a plurality of optical filters, wherein each of the optical filters transmits one of the channels of the light beam while reflecting the other channels of the light beam; and
focusing each of the channels of light transmitted by the each of the optical filters into one of a plurality of output optical fibers.

46. The method of claim 45, wherein each of the output optical fibers receives a different one of the channels of the multiwavelength light.

47. The method of claim 46, wherein the reflecting of the light beam is performed serially so that each of the optical filters reflects the light beam to another one of the optical filters until all of the optical filters have reflected the light beam once.

48. The method of claim 46, further comprising the steps of:
emitting free-space beams of light from the output optical fibers;
collimating the beams of light;
reflecting the beams of light using the optical filters to combine the beams of light into a single beam of light; and
focusing the single beam of light into the input optical fiber.

49. The method of claim 47, wherein the optical filters are disposed in a pair of opposing columns so that the light beam is reflected in a zigzag pattern.

50. The method of claim 47, wherein the reflecting of the light beam includes reflecting the beam of light off a plurality of mirrors so that each of the mirrors receives the light beam reflected by one of the optical filters and reflects the received light beam to another of the optical filters.

51. The method of claim 50, wherein the optical filters are disposed in a first column and the plurality of mirrors are disposed in a second column opposing the first column so that the light beam travels in a zigzag pattern as the light beam is reflected by the optical filters and the optical mirrors.

52. The method of claim 50, wherein the optical filters are disposed in a first arcuate pattern and the plurality of mirrors are disposed in a second arcuate pattern facing the first arcuate pattern so that the light beam travels in an arcuate zigzag pattern as the light beam is reflected by the optical filters and the optical mirrors.

53. The method of claim 52, wherein a radius of curvature of the first arcuate pattern is greater than that of the second arcuate pattern.

54. The method of claim 52, wherein the plurality of mirrors are integrally formed together as distinct planar facets of a unitary arcuate-shaped optical element.

55. The method of claim 46, wherein a frequency separation between adjacent ones of the channels does not exceed 100 GHz, and wherein each of the optical filters reflects the received light beam by no more than 20 degrees away from the received light beam.

56. The method of claim 46, further comprising the steps of:
collimating one of the channels of the light emitted from an output end of one of the output optical fibers to form a second free-space beam of the light, wherein the one channel of the light includes a plurality of predetermined sub-channels of light each having a distinct predetermined range of wavelengths;
reflecting the second light beam off a plurality of second optical filters, wherein each of the second optical filters transmits one of the sub-channels of the light beam while reflecting the other sub-channels of the light beam; and
focusing each of the sub-channels of light transmitted by the each of the second optical filters into one of a plurality of second output optical fibers;
wherein each of the second output optical fibers receives a different one of the sub-channels of the light.

57. The method of claim 46, further comprising:
passing the light beam through a band optical filter that reflects a predetermined number of the light channels to form a second light beam;
reflecting the second light beam off a plurality of second optical filters, wherein each of the second optical filters transmits one of the predetermined number of channels of the second light beam while reflecting the other predetermined number of channels of the second light beam; and
focusing each of the predetermined number light channels transmitted by the each of the second optical filters into one of a plurality of second output optical fibers.

58. The method of claim 46, further comprising:
forming a second light beam from the first light beam after the first beam of light has reflected off of the plurality of optical filters, wherein the second light beam includes a plurality of second channels of light each having a distinct predetermined range of wavelengths;
reflecting the second light beam off a plurality of second optical filters, wherein each of the second optical filters transmits one of the second channels of the second light beam while reflecting the other second channels of the second light beam; and
focusing each of the second channels of light transmitted by the each of the second optical filters into one of a plurality of second output optical fibers;
wherein each of the second output optical fibers receives a different one of the second channels of the second light beam.

59. An optical device for multiplexing and de-multiplexing multiwavelength light, comprising:
a base plate having a surface;
a first optical collimator mounted to the base plate surface for receiving multiwavelength light from an input optical fiber and producing a substantially collimated free-space beam of the light, wherein the multiwavelength light includes a plurality of predetermined light channels each having a distinct predetermined range of wavelengths;
a first optical filter mounted to the base plate surface for receiving the light beam from the first optical collimator, wherein the first optical filter transmits one of the light channels of the received light beam while reflecting the other light channels of the received light beam;
a second optical collimator mounted to the base plate surface for focusing the one light channel transmitted by the first optical filter into a first output optical fiber;
a second optical filter mounted to the base plate surface for receiving the other light channels reflected by the first optical filter, and for reflecting the received other light channels;
a third optical collimator mounted to the base plate surface for focusing the other light channels reflected by the second optical filter into a second output optical fiber; and
a fourth optical collimator mounted to the base plate surface for receiving light from a second input optical fiber and producing a substantially collimated second free-space beam of the light, and for directing the second light beam through the second optical filter and to the third optical collimator for focusing into the second output optical fiber.

60. The optical device of claim 59, wherein the second light beam includes a channel of light having a predetermined range of wavelengths that is substantially the same as that for the channel of light transmitted by the first optical transmitter.
